(19) United States
(12) Patent Application Publication
(10) Pub. No.: US 2008/0027768 A1
(43) Pub. Date: Jan. 31, 2008

(54) Automated Repricing of Revised Itineraries for Ticket Changes Requested After Issuance

(76) Inventors: Steve Thurlow, Kansas City, MO (US); Kami Link, Kansas City, MO (US); Ruthie Welkey, Kansas City, MO (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(21) Appl. No.: 11/778,444

(22) Filed: Jul. 16, 2007

Related U.S. Application Data
(60) Provisional application No. 60/820,296, filed on Jul. 25, 2006.

(51) Int. Cl. G01C 21/34

(52) U.S. Cl. 705/6

(57) ABSTRACT

A system, method, and computer readable medium for returning the different costs for multiple potential travel alternatives using a single travel change request. The itinerary information is analyzed to determine fare rules and requirements to follow in repricing a new ticket. The process builds alternative flight criteria based on the requested travel change. The alternative flight criteria are then matched with fare data that is associated with the markets for the new itinerary. When the available flight information has been accessed along with the best available fares, this information is used to query available seat inventory on the target flights. Using the information from the targeted flights, alternative itinerary solutions are driven through the repricing process to determine the cost of each proposed itinerary for the requested change. With multiple answers to the request, full alternative costs can be proposed to a customer to make a change decision that best meets the customer's needs.

### CROSS-REFERENCE TO RELATED APPLICATION

The present patent application is a formalization of a previously filed, co-pending provisional patent application entitled “Automated Repricing of Alternative Itineraries for Ticket Changes Requested After Issuance,” filed on Jul. 25, 2006, as U.S. patent application Ser. No. 60/820,296 by the inventors named in this patent application. This patent application claims the benefit of the filing date of the cited provisional patent application according to the statutes and rules governing provisional patent applications. The specification and drawings of the provisional patent application are specifically incorporated herein by reference.

### BACKGROUND OF THE INVENTION

The present invention relates generally to repricing of travel itineraries and, more particularly, to an automated process that can consider and apply variances in the numerous factors that affect ticket repricing to provide a customer with revised itineraries and associated costs in changing travel plans.

Upon the request of a passenger or based on airline operational necessity, it may be necessary for an agent to reissue a passenger's electronic or paper ticket for air transportation. Air travel customers have the need to understand the cost of available travel solutions when changing travel plans. Currently, this understanding requires extensive manpower to consider numerous factors in establishing the cost of revised travel choices. Ticket prices can vary based on such factors as time of travel, alternative airports, travel routings, available seat inventory and offered fares.

The travel industry has been looking for a method to automate the reissue/refund process for tickets. Current reissue processing for additional collections and refunds are generally calculated manually by each carrier and/or agency. This is a very time consuming and labor intensive process resulting in possible incorrect calculations.

Existing ticket re-issuance products, such as “Rapid Reprice” which is available from Worldspan LP, work in the following manner. A customer requests a change to an existing ticket. Changes are made to the ticket to reflect the customer's changed travel request. The old ticket information and the new ticket information are sent to software that analyze the itinerary and look in historical databases for the rules that applied to the ticket when it was originally issued. Based on the original fare rules the ticket may be priced using several different processes. Once the appropriate fares are found for the new ticket and the appropriate fees are applied, the customer is advised of the change costs and the customer can determine if they want to pursue that specific itinerary change.

Although a requested itinerary change now can be handled more efficiently than with the old manual methodology, the current automated methods provide a single solution, which the customer must either accept or leave his current itinerary/ticket unchanged. There is a need for a repricing process that recalculates revised itineraries for a traveler from an already ticketed reservation.

### SUMMARY OF THE INVENTION

Embodiments of the present invention are directed to a system and method for returning the different costs for multiple potential revised travel itineraries using a single travel change request. The inventive process is activated using multiple sources of information and messaging tools when an itinerary change request is made. The old ticket information is sent with the changed ticket information. The itinerary information is then analyzed to determine fare rules and requirements to follow in repricing a new ticket. The process of the invention then builds alternative flight criteria based on the requested travel change. The alternative flight criteria are then matched with fare data that is associated with the markets for the new itinerary. When the available flight information has been accessed along with the best available fares, this information is used to query available seat inventory on the target flights. Using the information from the targeted flights, alternative itinerary solutions are driven through the repricing process to determine the cost of each proposed itinerary for the requested change. With multiple answers to the request, full alternative costs can be proposed to a customer to make a change decision that best meets the customer's needs.

Upon the request of a change to the itinerary by the passenger, the new itinerary must be repriced and a new ticket issued if the passenger chooses to accept the new price. Itinerary and Passenger Name Record (PNR) information will be processed through a newly defined record. The automated repricing system will compare the original itinerary to the new itinerary to determine how it has been changed and then obtain the fare rule data that was in place when that itinerary was ticketed. Fares used on the original ticket will dictate the reprice restrictions that apply. Involuntary changes to the itinerary must be disregarded during the itinerary comparison process. The information will then be driven through the automated repricing system. To re-price the itinerary the automated repricing system may, based on original fare rule requirements, utilize the previous fares from the original ticket, reprice using current fares, reprice using historical fares that were in effect at the time the original ticket was issued or use a combination of current and historical fares. The automated repricing system will provide the best repricing solution along with any applicable penalty information to be used to reissue a new ticket.

In one aspect of the invention, a method, system, and computer readable medium is provided for automatic repricing of a revised travel itinerary. The method includes the steps of receiving a ticket change request from a passenger; analyzing a plurality of itinerary changes; building a plurality of alternate flight selection criteria; selecting target fares and determining classes of service criteria through interaction with a fares database; building and automatically repricing alternate itineraries for a plurality of selected flight candidates; and displaying a plurality of results from the repriced alternate itineraries for selection by the passenger. The system includes components operating on a processor for executing the steps of the method. The computer readable medium contains program instructions that enable the steps of the method when executed on a computer system.

In another aspect of the invention, a method, system, and computer readable medium is provided for pricing of alternate travel itineraries. The method includes the steps of receiving a request to price a specific market without an itinerary; analyzing a plurality of travel options requested including dates of travel, destinations, and times of departure or arrival; selecting target fares and determining classes of service criteria through interaction with a fares database; selecting a plurality of qualified flight candidates associated with the lowest target fares to build alternate itineraries; repricing each alternate itinerary to determine a plurality of lowest fare results; and displaying a plurality of the resulting lowest fare itineraries including a total price for each itinerary displayed. The system includes components operating on a processor for executing the steps of the method. The computer readable medium contains program instructions that enable the steps of the method when executed on a computer system.

In another aspect of the invention, a method, system, and computer readable medium is provided for repricing a new itinerary. The method includes the steps of comparing an originally ticketed itinerary to the new itinerary to determine the changes made by a passenger; building a plurality of alternate flight selection criteria; selecting a plurality of target fares and determining a plurality of available classes of service using a fares database; building a plurality of alternate itineraries to submit for an automated recalculation of fares; repricing each alternate itinerary based on a plurality of reissue provisions and any applicable waivers; and displaying a plurality of alternate itineraries having the lowest fare results. The system includes components operating on a processor for executing the steps of the method. The computer readable medium contains program instructions that enable the steps of the method when executed on a computer system.

### BRIEF DESCRIPTION OF THE DRAWINGS

These and other advantages and aspects of the present invention will become apparent and more readily appreciated from the following detailed description of the invention taken in conjunction with the accompanying drawings, as follows.

FIG. 1 illustrates a high level flowchart of the processing logic for automated repricing of alternative itineraries for an issued ticket in accordance with an exemplary embodiment of the invention.

FIG. 2 illustrates exemplary processing logic for an itinerary and pricing search tool that is integrated into the automated system for repricing of alternative travel itineraries.

FIG. 3 illustrates exemplary processing logic for an automated tool for recalculating fares when itineraries change that is integrated into the automated system for repricing of alternative travel itineraries.

FIGS. 4A-4H represent an example of the displays generated by the automated repricing system in accordance with an exemplary embodiment of the invention.

FIGS. 5A-5G illustrate a processing example for repricing of revised itineraries.

FIG. 6 illustrates a repricing data map in accordance with an exemplary embodiment of the invention.

### DETAILED DESCRIPTION OF THE INVENTION

The following description of the invention is provided as an enabling teaching of the invention and its best, currently known embodiment. Those skilled in the art will recognize that many changes can be made to the embodiments described while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations of the invention are possible and may even be desirable in certain circumstances and are part of the present invention. Thus, the following description is provided as illustrative of the principles of the invention and not in limitation thereof since the scope of the present invention is defined by the claims.

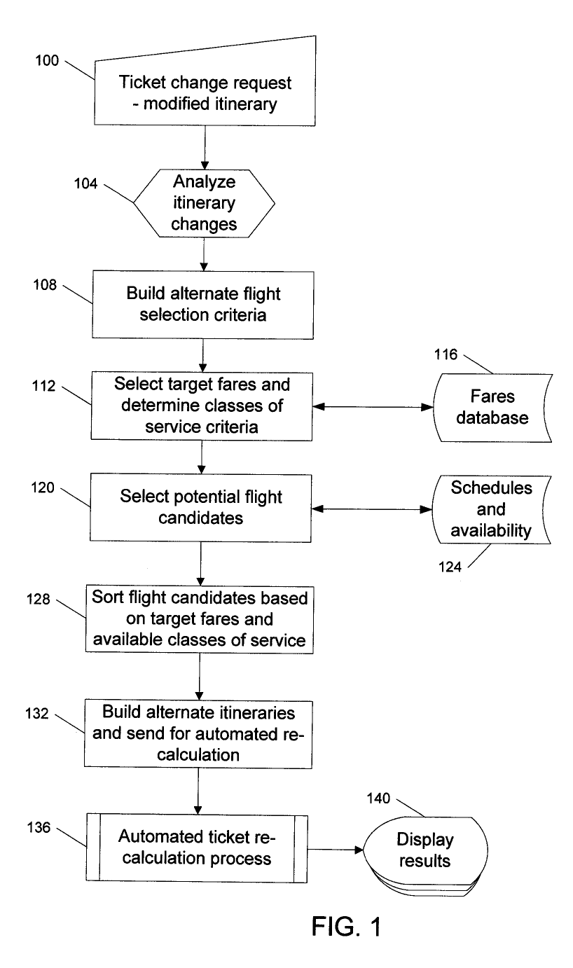

FIG. 1 illustrates a high level flowchart of the processing logic for automated repricing of alternative itineraries for an issued ticket. Automated repricing processing begins with a request for a ticket change as indicated in logic block 100. This step can be initiated by the passenger or an agent at a display terminal. A customer needs to be able to change an itinerary either before or during the trip. A reissue product calculates how much the change will cost, or in some cases when the fare has gone down, the amount of a refund that is due. The processing logic then analyzes the requested itinerary changes as indicated in logic block 104. The reissue rules that are applied could be based on where and how an itinerary is changed. For example, a change before departure could mean that some pricing alternates can not be used. The next step in the process involves building alternate flight selection criteria as indicated in logic block 108. There are many alternate flights based on time of day and routing construction that can be used as replacement flights. This process gathers the criteria used to select alternate flights as potential candidates. Target fares are selected and classes of service criteria are determined as indicated in logic block 112. This process uses a computer algorithm in order to pinpoint target fares that the customer may be able to qualify for when driving the calculations through the pricing algorithm in a subsequent process. The target fares are obtained through search/interface with the fares database 116. The fares database is a database of fares ordered by market and carrier.

Potential flight candidates are then selected as indicated in logic block 120 through search/interface with the schedules and availability database 124. This process uses a computer algorithm to assign values to flights. Flights with the best scores will become candidates to be driven through the pricing algorithm. The schedules and availability database is a database of flight information as the name suggests. The processing logic automatically sorts flight candidates based on target fares and available classes of service as indicated in logic block 128. Classes of service are used by airlines to restrict the number of seats in different price groups. A good flight candidate needs to have the right classes of service available. Next, as indicated in logic block 132, the processing logic builds alternate itineraries and sends them to the pricing function for automated recalculation of ticket price for each alternate itinerary. The information gathered in the analyze itinerary process (logic block 104) is sent with the highest scored candidates to drive through the pricing algorithm. The automated ticket recalculation process is indicated in processing logic block 136. Based on the results returned from each of the flight candidates, the best results can be sorted to offer the customer the best alternates. These alternates can be offered for use to reissue a ticket. The results for the alternative itineraries are then displayed to the ticket change requester as indicated in block 140 for selection by the passenger of one itinerary from the alternatives presented. The alternate itineraries displayed include fare difference and fees (i.e., the total additional amount to collect or the amount of refund to provide). The results can be displayed on the hosting system, or information can be passed to a non-hosted system for its own method of display.

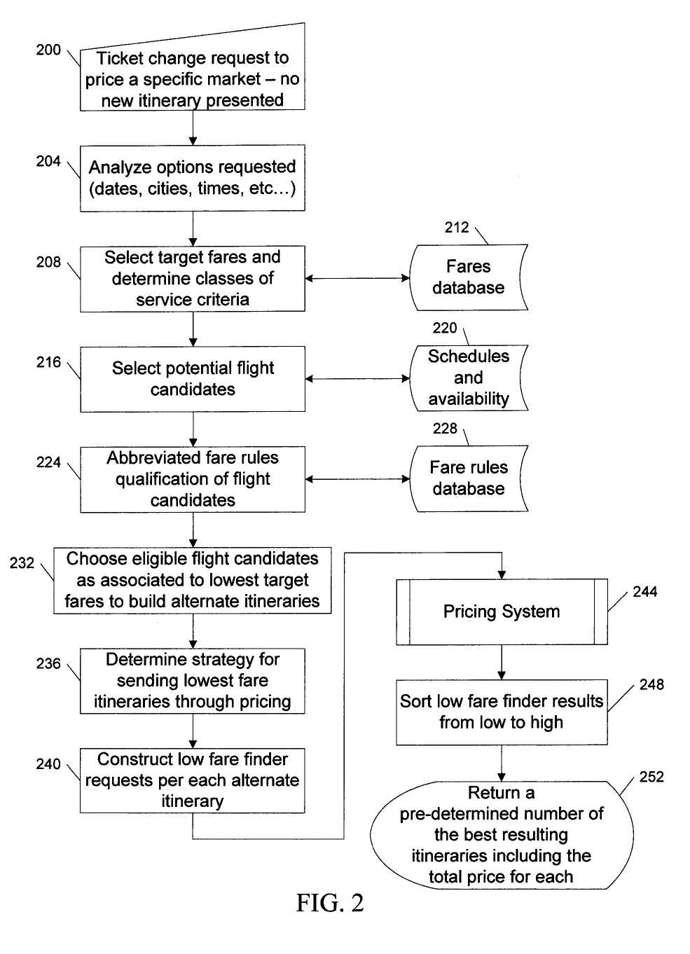

FIG. 2 illustrates exemplary processing logic for an itinerary and pricing search tool that is integrated into the automated system for repricing of alternative travel itineraries. The processing logic is invoked in logic block 200 with a request to price a specific market without presentment of an itinerary. As indicated in logic block 204, the itinerary and pricing search tool analyzes the options that are requested, such as dates, cities, times, etc. The processing logic then selects target fares and determines classes of service criteria as indicated in logic block 208. This step is performed via interaction with the online fares database 212. The processing logic next selects potential flight candidates in logic block 216 through interaction with the online schedules and availability database 220. The processing logic performs an abbreviated fare rules qualification of flight candidates in logic block 224 through interaction with the fare rules database 228.

After performing an abbreviated fare rules qualification of flight candidates, the itinerary and pricing search tool choosing eligible flight candidates associated with lowest target fares to build alternate itineraries as indicated in logic block 232. As indicated in logic block 236, the processing logic then determines a strategy for sending the lowest fare itineraries through pricing. Lowest fare requests are constructed for each alternate itinerary as indicated in logic 240. The alternate itineraries are run through the pricing system as indicated in logic block 244. The lowest fare results are sorted from lowest to highest in logic block 248. A predetermined number of the best resulting itineraries including the total price for each itinerary is returned to the requester's display in block 252.

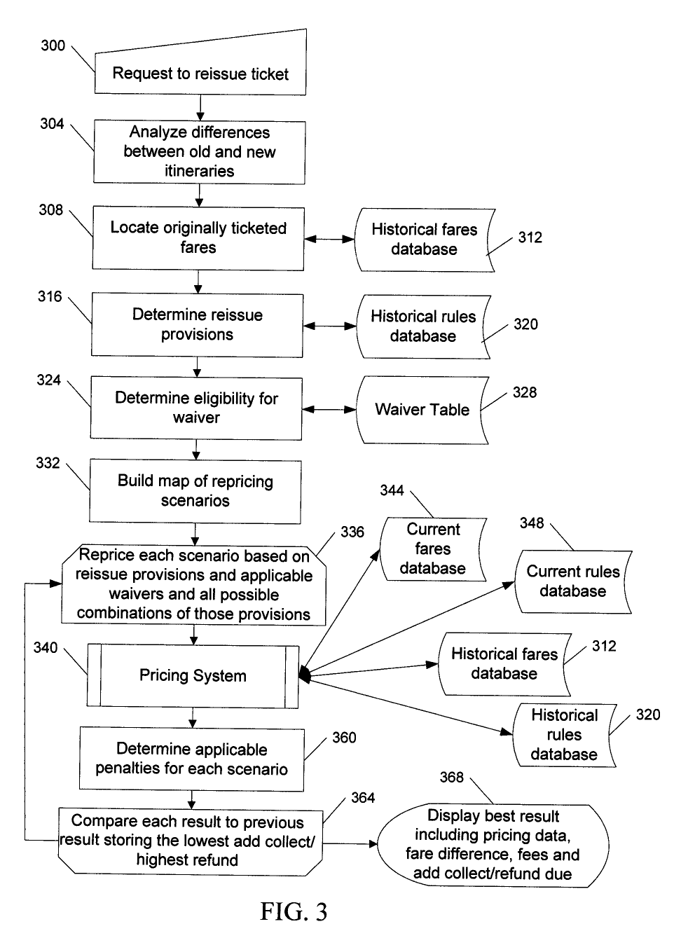

FIG. 3 illustrates exemplary processing logic for an automated tool for recalculating fares when itineraries change that is integrated into the automated system for repricing of alternative travel itineraries. The processing logic is invoked in logic block 300 with a request to reissue a ticket. The differences between the old and new itineraries are analyzed in logic block 304. The processing logic locates the originally ticketed fares in logic block 308 through interaction with online historical fares database 312. Next, the ticket reissue provisions are determined in logic block 316 through interaction with historical rules database 320. The processing logic determines eligibility for waiver of the reissue provisions in logic block 324 through interaction with waiver table 328.

A map of the repricing scenarios is then built as indicated in logic block 332. This is followed in logic block 336 with a request for repricing of each scenario based on reissue provisions and applicable waivers, and all possible combinations of these provisions. The pricing system is then entered in logic block 340 to price the various scenarios. In performing its calculations, the pricing system interacts with current fares database 344, current rules database 348, historical fares database 312 and historical rules database 320. The processing logic determines the applicable fees for each scenario run through the pricing system as indicated in logic block 360. Each result is compared to the previous result storing the lowest add collect or highest refund as indicated in logic block 364. The best result is then displayed to the requester in block 368.

Depending on whether or not the itinerary is modified prior to initiating the automated repricing of alternative itineraries system, the “Results” screen returned to the ticket change requester will differ. If the itinerary has been modified, it is assumed that the passenger requires reissue information for the specific flight or flights chosen in the rebook. In an exemplary embodiment, the Results screen will reflect that information first, followed by additional alternates based on flight candidates processed through the itinerary and pricing search tool and the pricing results on those candidates. If the itinerary has not been modified prior to initiating the automated repricing of alternative itineraries system, the Results screen will reflect multiple alternatives in an exemplary embodiment based on the flight candidates selected through the itinerary and pricing search tool and the pricing results on those candidates.

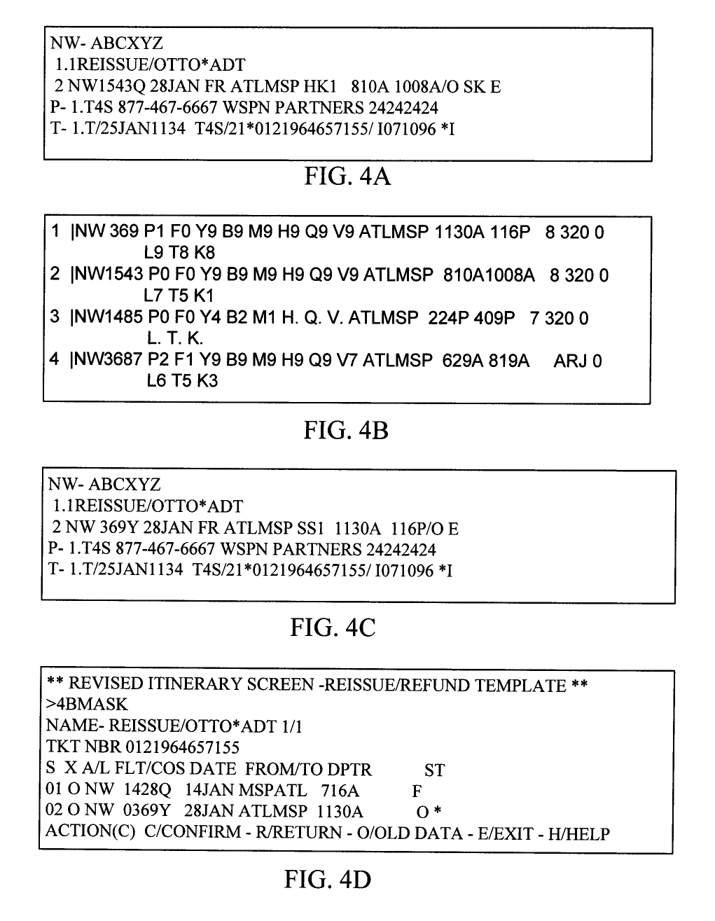

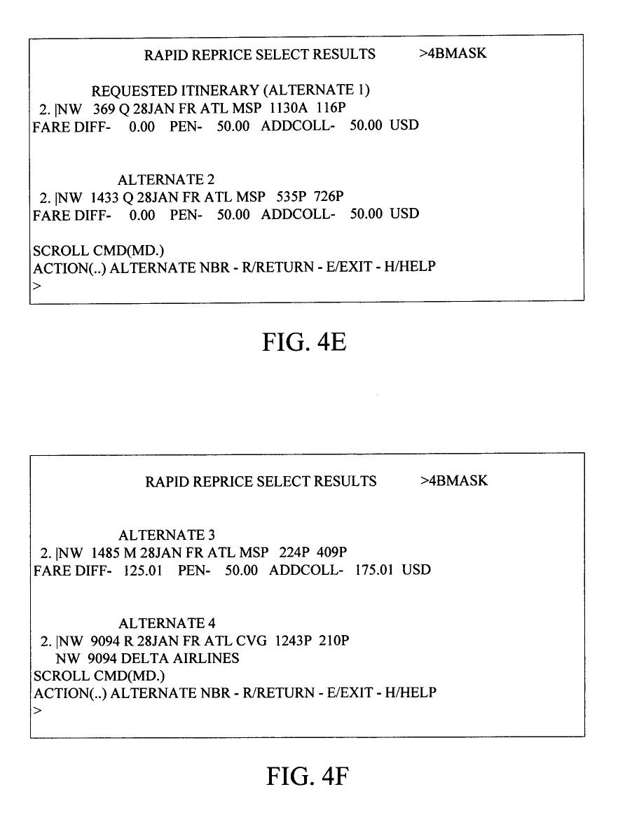

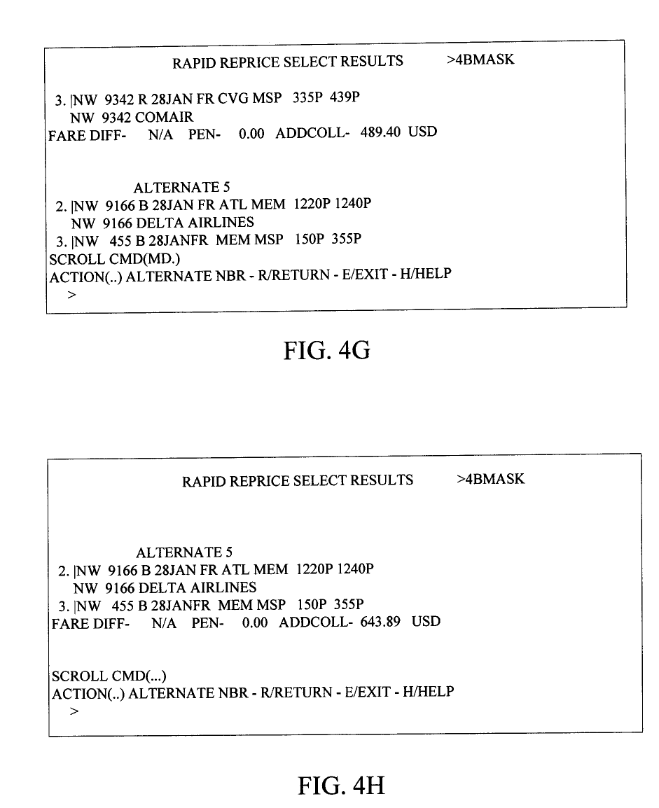

FIGS. 4A-4H represent an example of the displays generated by the automated repricing system when the itinerary is modified prior to initiating the automated repricing of alternative itineraries system. FIG. 4A displays the original itinerary that has not yet been modified. The passenger wants to change the January 28 flight from Atlanta to Minneapolis St. Paul. The itinerary and pricing search tool returns multiple alternates. A request for flight availability returns potential flight candidates as depicted in FIG. 4B. The passenger selects Northwest flight 369 which is reflected in the modified itinerary screen of FIG. 4C. The automated repricing of alternative itineraries system is entered and generates the revised itinerary screen shown in FIG. 4D. This screen shows the complete itinerary including both the outbound leg that has been flown and the return leg that has been modified. More alternates may be allowed based on customer requirements.

The requester then confirms the itinerary to automated repricing of alternative itineraries system which then generates the scrollable “Results” screen depicted in FIGS. 4E-4H. The requested itinerary and all alternates displayed include all flight segments, whether changed or not. The requested itinerary is listed first as depicted in FIG. 4E (alternate 1). However, this may not be the best result when compared to other alternates. Each alternate result display includes a header identifying the result (e.g., alternate 2). Any fare differences, fees, additional collections or refunds will also be displayed. The last two lines on each Results screen depict the scroll command field and the action command field, respectively. The scroll command field will display additional data for the alternate results until all results have been displayed. The action field allows the user to return to the revised itinerary screen (FIG. 4D) or exit the process.

The following discussion provides an overview of the processing that is needed to automatically reprice each proposed itinerary when a ticket change request is initiated. Itinerary and Passenger Name Record (PNR) information for a ticket change request are processed based on predefined reissue rules in effect when a ticket is purchased. The automated repricing software analyzes the ticket data and interrogates the applicable reissue rules to determine the repricing processing options to use. The information is then driven through the repricing software. The automated repricing software provides a repriced itinerary and applicable fee information that can be used to reissue the ticket. To reprice an itinerary, the automated repricing software, based on reissue rules requirements, utilizes previously priced fares from the ticket record, prices using current fares, historical fares or uses a combination of these pricing options. The repricing solutions are displayed and/or sent back to the requestor for the reissue process to continue if the passenger accepts the repricing result.

Certain software functionality and data access are required to reprice for reissue purposes. These include access to a historical fares database; access to a historical rules database; access to original ticket data; access to a carrier profile record, unique processing information specific to a carrier; the ability to calculate applicable transportation taxes; the ability to determine the original ticketed itinerary and passenger type code; the ability to automatically price itineraries using fares from the original ticket, current fares, historical fares or a combination of fares; and the ability to automatically price itineraries using current or historical fare construction and pricing logic.

Once itinerary information is received, the automated repricing software must analyze the information and determine how to process it for pricing. Each carrier can supply the automated ticket repricing system with the methods to use in processing the itinerary data. The following general information must be determined based on the carrier and the itinerary: (1) the carrier or travel agency that initiated the automated reissue request; (2) the original ticketed itinerary (including the fare class codes, fare break points, fare amounts and ticketing date); (3) the passenger's new itinerary, if one exists; (4) the first point of change to determine which priceable units were affected by the change; (5) the flown and unflown segments; and (6) the carrier specified original reissue rules in effect when the ticket was issued.

Once the itinerary has been analyzed, the information is driven through the pricing system based on carrier intent filed with reissue rules. The automated repricing software will attempt to reprice the itinerary using historical fares, current fares, fares from the ticketing record (including e-ticket), or a combination of the fares based on the processing options selected by each carrier. The pricing system includes various repricing options based on fully flown, partially flown and unflown fare components within the itinerary. Depending on the reissue rules, processing will check availability for classes of services booked and a process to find the lowest fare solution will be attempted. The current date is used when repricing using current fares. The lowest fare add collect or highest refund calculated is used for the result.

When historical pricing processing is invoked, an online request is made to access the historical database and build at least one market city pair record. The record will contain various historical information including historical fares. Rule records will also be accessed from a historical rules database maintained in the online system. The ticketing date will be the date used to access the historical databases.

The following paragraphs provide a more detailed discussion of the automated repricing system and method. The following are the specific steps that must be performed in order to process a reissue in an exemplary embodiment:
1. compare the originally ticketed itinerary and the new itinerary to determine what changes were made by the passenger;
2. determine if the change is being made before or after departure based on the flight coupon status from the original ticket;
3. analyze the original ticket's fare ladder to determine the original fare construction;
4. build alternate flight selection criteria;
5. select target fares and determine classes of service criteria using a fares database;
6. select potential flight candidates using schedules and availability;
7. sort flight candidates based on target fares and available classes of service;
8. build alternate itineraries and send for automated recalculation;
9. access the historical fares database to locate the original fare data and determine the applicable reprice scenarios and restrictions based on the fare rule data associated with the originally ticketed fares;
10. build a repricing map with all applicable repricing scenarios and restrictions;
11. reprice each scenario based on reissue provisions and applicable waivers and all possible combinations of those provisions;
12. determine applicable penalties for each scenario;
13. compare each result to previous result storing the lowest add collect/highest refund;
14. display the best results for the passenger including pricing data, fare difference, fees and add collect/refund due.

Processing options (tags) are the basic principles which will be applied when re-pricing an itinerary in the automated repricing system. Each carrier selects and files rules specifying which process tags are to be used when re-pricing itineraries. Process tags are evaluated and combined into pricing tags. Applicable pricing tags are processed in combination with all applicable fare rules. An attempt is made to re-price the itinerary using all options filed by that carrier and the lowest re-pricing solutions are displayed. In addition to the processing tags filed by the carriers, the system will attempt to price multiple alternate itineraries and provide options for the passenger to reissue the ticket.

The processing options described in the following paragraphs can be used in the automated repricing system based on selections by each specific carrier:

Option 1: Attempt to re-price the entire itinerary, whether fare components are flown, partially flown or un-flown, using the same fares as originally ticketed. In an exemplary embodiment, this will be referred to as Tag A.

Option 2: Attempt to re-price keeping the historical same fares for all unchanged fare components (flown, partially flown, or un-flown) up to the beginning of the first changed fare component. Use current fares from the beginning of the first changed fare component. In an exemplary embodiment this will be referred to as Tag B.

Option 3: Attempt to re-price keeping the historical same fares for any fully flown fare components. For partially flown and any un-flown fare components, apply current fares. In an exemplary embodiment this will be referred to as Tag C.

Option 4: Attempt to re-price the itinerary using historical new fares for fully flown fare components. For partially flown and any un-flown fare components, apply current fares. In an exemplary embodiment this will be referred to as Tag D.

Option 5: Attempt to re-price the entire itinerary whether flown, un-flown, new or changed segments using historical new fares. In an exemplary embodiment this will be referred to as Tag E.

Option 6: Attempt to re-price the entire itinerary using current fares. In an exemplary embodiment this will be referred to as Tag F.

Option 7: Determine a residual value for the itinerary using historical fares for flown portions of the itinerary. Then apply that value to un-flown portions that have been priced with current fares. More specifically, this option requires the following two steps: (Step 1) Attempt to re-price all flown segments using historical new fares. Determine the value of transportation flown by subtracting flown re-priced solution from original ticket price. Save any residual value; any negative residual value is ignored. (Step 2) Attempt to re-price all un-flown flight segments using current fares. Apply any residual value from Step 1. In an exemplary embodiment, this will be referred to as Tag G.

Option 9: Attempt to re-price keeping historical same fares for all unchanged fare components (flown, partially flown or un-flown) up to the beginning of the first changed fare component. Use historical new fares from the beginning of the first changed fare component. Use original fare breaks. In an exemplary embodiment this will be referred to as Tag H.

Option 10: Ignore all flown segments. Attempt to re-price all un-flown segments using current fares. In an exemplary embodiment this will be referred to as Tag I.

The following describes the steps that an agent makes when processing a ticket reissue request from a customer:
1. create or retrieve passenger's reservation and determine changes requested by passenger;
2. initiate rapid repricing process;
3. verify new itinerary and confirm to continue;
4. repricing begins and final results are displayed to the agent; and
5. if passenger accepts one of the new results, fare can be stored and ticket reissued; if passenger refuses the results, the PNR can be ignored.

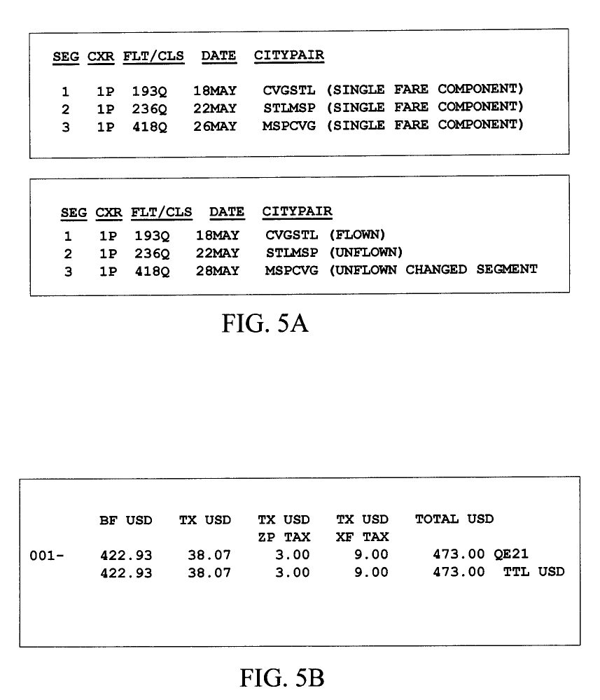

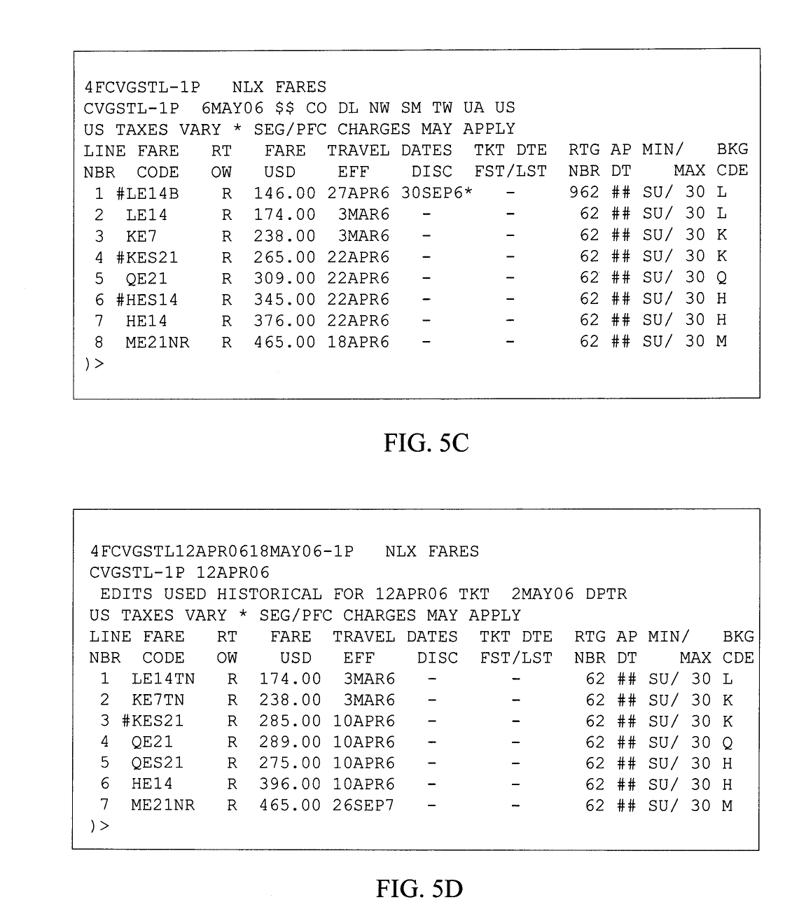

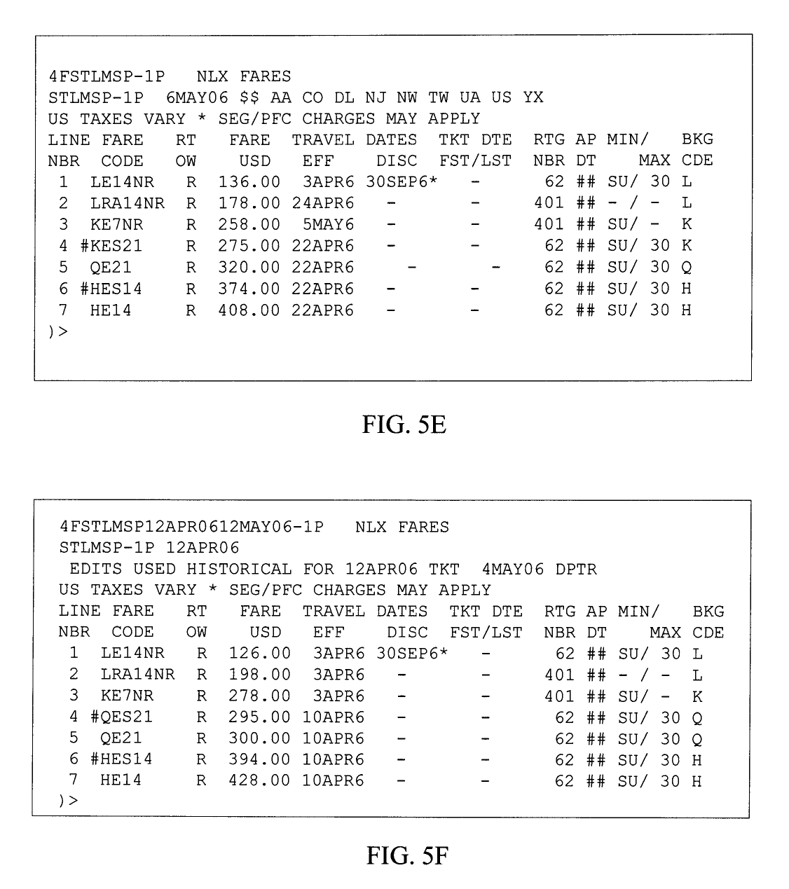

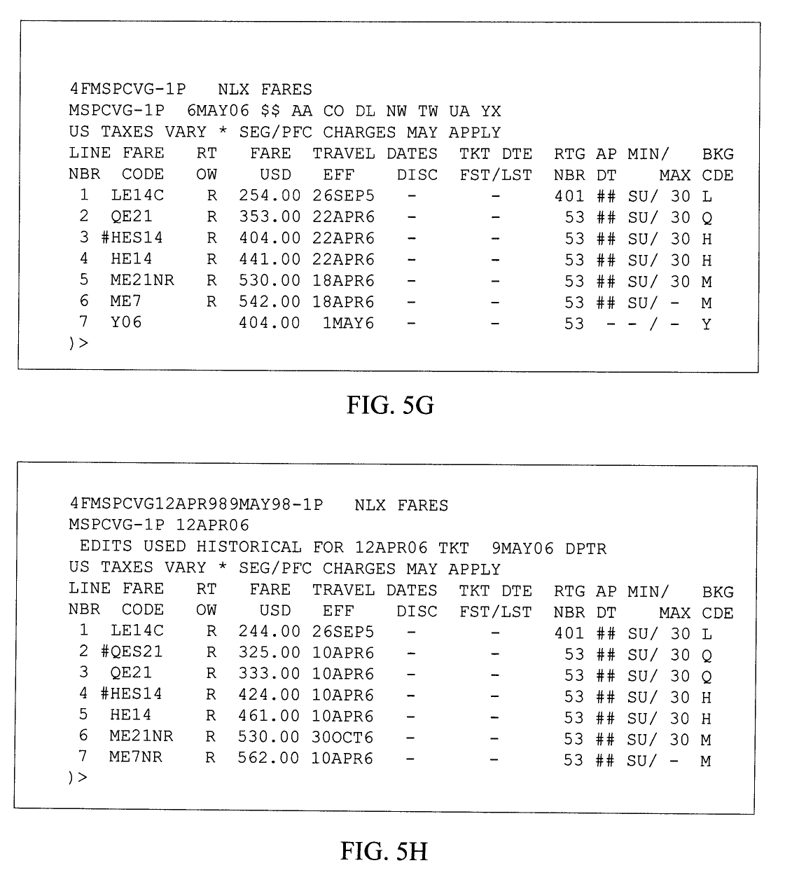

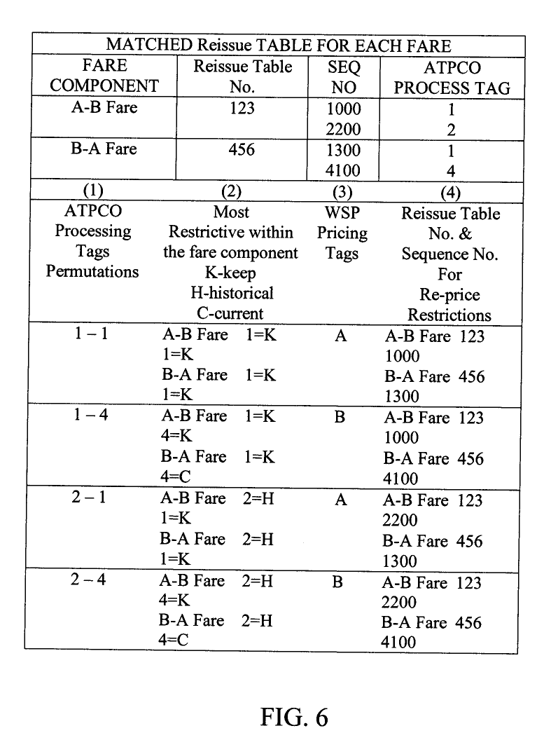

The following examples and figures show how each tag determines a new re-pricing result. FIGS. 5A-5G illustrate a processing example for repricing of revised itineraries. FIG. 5A shows both the original ticketed itinerary and the changed itinerary. FIG. 5B shows that the original fare was ticketed on April 12 for travel beginning on May 18, with a total fare price of $473.00 and a fare code of QE21. FIGS. 5C-5D illustrate a current fare display and a historical fares display, respectively, for the travel leg between Cincinnati and St. Louis. FIGS. 5E-5F illustrate a current fare display and a historical fares display, respectively, for the travel leg between St. Louis and Minneapolis-St. Paul. FIGS. 5G-5H illustrate a current fare display and a historical fares display, respectively, for the travel leg between St. Louis and Minneapolis-St. Paul.

TAG A Example:

Attempt to re-price the entire itinerary (whether fare components are flown, partially flown or un-flown) using the same fares as originally ticketed.

| | | | TX USD | TX USD | |
|---|---|---|---|---|---|
| | BF USD | TX USD | ZP TAX | XF TAX | TOTAL USD |
| 001 | 422.93 | 38.07 | 3.00 | 9.00 | 473.00 QE21 |
| | 422.93 | 38.07 | 3.00 | 9.00 | 473.00 TTL |

USD
ADT CVG 1P STL 132.571P MSP 137.611P CVG 152.75USD422.93END 1P
ZPCVG1STL1MSP1 XF CVG3STL3MSP3)

Penalty Amount: $75.00 (from original fare)

Original fare amount: $473.00

Additional Collection: $75.00

TAG B Example:

Attempt to re-price keeping the historical same fares for all unchanged fare components (flown, partially flown or un-flown) up to the beginning of the first changed fare component. Use current fares from the beginning of the first changed fare component.

| | | | TX USD | TX USD | |
|---|---|---|---|---|---|
| | BF USD | TX USD | ZP TAX | XF TAX | TOTAL USD |
| 001 | 386.69 | 34.81 | 3.00 | 9.00 | 433.50 |
| | | | | | QE21*LE14C |
| | 386.69 | 34.81 | 3.00 | 9.00 | 433.50 TTL |

USD
ADT CVG 1P STL 132.571P MSP 137.611P CVG 116.51USD386.69END 1P
ZPCVG1STL1MSP1 XF CVG3STL3MSP3)> REBOOK 03/L

Penalty amount: $75.00
Original fare amount: $473.00
New fare amount: $433.50

Additional Collection: $35.50 (75.00−39.50)

The use of lowest fare processing for the un-flown changed fare component resulted in a total fare $39.50 less than the original fare. However, because of the $75.00 penalty, an additional collection of $35.50 is due.

TAG C Example:

Attempt to re-price keeping the historical same fares for any fully flown fare components. For partially flown and any un-flown fare components apply current fares.

| | BF | TX | TX USD | TX USD | |
|---|---|---|---|---|---|
| | USD | USD | ZP TAX | XF TAX | TOTAL USD |
| 001 | 311.46 | 28.04 | 3.00 | 9.00 | 351.50 |
| | | | | | QE21*LE14NR*LE14C |
| | 311.46 | 28.04 | 3.00 | 9.00 | 351.50 TTL |

ADT CVG 1P STL 132.571P MSP 62.381P CVG 116.51USD311.46END 1P
ZPCVG1STL1MSP1 XF CVG3STL3MSP3 * REBOOK 02/L 03/L

Penalty amount: $75.00
Original fare amount: $473.00
New fare amount: $351.50
Additional Collection: 0; Refund due: $46.50 (121.50−75.00)

The use of lowest fare processing for the un-flown and changed segments resulted in a total fare $121.50 less than the original fare; therefore a refund would be due.

TAG D Example:

Attempt to re-price the itinerary using historical new fares for fully flown fare components. For partially flown and any un-flown fare components apply current fares.

| | BF | TX | TX USD | TX USD | |
|---|---|---|---|---|---|
| | USD | USD | ZP TAX | XF TAX | TOTAL USD |
| 001 | 305.03 | 27.47 | 3.00 | 9.00 | 344.50 |
| | | | | | QES21*LE14NR*LE14C |
| | 305.03 | 27.47 | 3.00 | 9.00 | 344.50 TTL |

USD
ADT CVG 1P STL 126.141P MSP 62.381P CVG 116.51USD305.03END 1P
ZPCVG1STL1MSP1 XF CVG3STL3MSP3 REBOOK 02/L 03/L

Penalty amount: $75.00
Original fare amount: $473.00; New fare amount: $344.50
Additional Collection: 0; Refund due: $53.50 (128.50−75.00)

The flown segment qualified for a lower QE21 fare. The use of lowest fare processing for the un-flown segments resulted in a total fare $128.50 less than the original fare; therefore a refund would be due.

TAG E Example:

Attempt to re-price the entire itinerary whether flown, un-flown, new or changed segments using historical new fares.

| | BF | TX | TX USD | TX USD | |
|---|---|---|---|---|---|
| | USD | USD | ZP TAX | XF TAX | TOTAL USD |
| 001 | 295.86 | 26.64 | 3.00 | 9.00 | 334.50 |
| | | | | | QES21*LE14NR*LE14C |
| | 295.86 | 26.64 | 3.00 | 9.00 | 334.50 TLL |

USD
ADT CVG 1P STL 126.141P MSP 57.801P CVG 111.92USD295.86END 1P
ZPCVG1STL1MSP1 XF CVG3STL3MSP3)> REBOOK 02/L 03/L

Penalty amount: $75.00
Original fare amount: $473.00; New fare amount: $334.50
Additional Collection: 0; Refund due: $63.50 (138.50−75.00)

Lowest fare processing will not be applied to the flown segments. The use of lowest fare processing for the un-flown segments resulted in a total fare $138.50 lower than the original fare; therefore a refund would be due.

TAG F Example:

Attempt to re-price the entire itinerary whether flown, un-flown, new or changed segments using current fares.

| | BF | TX | TX USD | TX USD | |
|---|---|---|---|---|---|
| | USD | USD | ZP TAX | XF TAX | TOTAL USD |
| 001 | 320.63 | 28.87 | 3.00 | 9.00 | 361.50 |
| | | | | | QE21*LE14NR*LE14C |
| | 320.63 | 28.87 | 3.00 | 9.00 | 361.50 TTL |

ADT CVG 1P STL 141.741P MSP 62.381P CVG 116.51USD320.63END 1P
ZPCVG1STL1MSP1 XF CVG3STL3MSP3 REBOOK 02/L 03/L

Penalty amount: $75.00
Original fare amount: $473.00; New fare amount: $361.50
Additional Collection: 0; Refund due: $36.50 (111.50−75.00)

The flown segment qualified for a current QE21 fare based on booking code ‘Q’. Use of lowest fare processing for the un-flown segments resulted in a combined total fare $111.50 less than the original fare; therefore a refund would be due

TAG G Example:

(Step 1) Re-price all flown segments using historical new fares. Determine the value of transportation flown by subtracting flown re-priced solution from the original ticket price. Save any residual value, negative residual value is ignored. (Step 2) Re-price all un-flown flight segments using current fares. Apply any residual value from Step 1.

| | BF | | TX USD | TX USD | |
|---|---|---|---|---|---|
| | USD | TX USD | ZP TAX | XF TAX | TOTAL USD |
| 001 | 178.89 | 16.11 | 2.00 | 6.00 | 203.00 |
| | | | | | LE14NR*LE14CTN |
| | 178.89 | 16.11 | 2.00 | 6.00 | 203.00 TTL |

USD
ADT STL 1P MSP 62.381P CVG 116.51USD178.89END 1P
1P ZPSTL1MSP1 XF STL3MSP3 REBOOK 02/L 03/L

Penalty amount: $75.00
Original fare amount: $473.00

Step 1: Re-price flown segment (CVGSTL) value $148.50 (132.57+11.93TAX+1.00ZP+3.00XF) New value of original ticket: $324.50 ($473.00−148.50)

Step 2: New fare amount $203.00. Additional Collection: 0; Refind due: $46.50 ($324.50−203.00−75.00)

The flown segment is ignored during re-pricing. The value of the original ticket $324.50, is $121.50 higher than the new total fare amount of $203. Therefore the $75 penalty amount is subtracted from the excess $121.50 to compute the refund of $46.50.

Following is an example of the same itinerary but processing Tag G using a two-fare component fare calculation:
CVGSTL=Fare Component 1 (flown), ½ QE21 at $100.00
STLMSP=Fare Component 2 (flown)
MSPCVG=Fare Component 2 (un-flown/changed), ½ QE21 at $100.00

| | | | TX USD | TX USD | |
|---|---|---|---|---|---|
| | BF USD | TX USD | ZP TAX | XF TAX | TOTAL USD |
| 001 | 227.50 | 22.50 | 2.00 | 6.00 | 258.00 Y25 |
| | 227.50 | 22.50 | 2.00 | 6.00 | 258.00 TTL |

USD
ADT MSP 1P CVG 227.50USD227.50END 1P ZPSTL1MSP1 XFSTL3MSP3

Penalty amount: $75.00
Original fare amount $200.00

Step 1: Re-priced flown segment value $444.98 (CVGSTL 63.89+STLCVG 339.81+30.28TAX+5.00ZP+6.00XF). New value of original ticket: $0; ($200.00−444.98)

Step 2: New fare amount $258.00. Additional Collection: $333.00 ($258.00+75.00)

The flown segments (CVGSTL and STLMSP) are ignored during re-pricing. Since the original ticket has no value, the $75.00 penalty amount is added to the new fare amount of $258.00 to calculate the additional collection of $333.00.

TAG H Example:

Attempt to re-price keeping historical same fares for all unchanged fare components (flown, partially flown or un-flown) up to the beginning of the first changed fare component. Use historical new fares from the beginning of the first changed fare component. Use original fare breaks.
Original fare QE21N round-trip @ $200.00 (CVGSTLMSP=Fare Component 1, MSPSTLCVG=Fare Component 2):
   CVGSTL
   STLMSP (½ QE21N at $100.00)
   MSPSTL
   STLCVG (½QE21N at $100.00)
Changed Itinerary:

CVGSTL=Fare Component 1 (flown)

STLMSP=Fare Component 1 (flown)

MSPSTL=Fare Component 2 (unflown/changed)

STLCVG=Fare Component 2 (unflown/changed)

| | | | TX USD | TX USD | |
|---|---|---|---|---|---|
| | BF USD | TX USD | ZP TAX | XF TAX | TOTAL USD |
| 001 | 216.66 | 17.34 | 8.00 | 12.00 | 254.00 QE21N |
| | | | | | QE21 |
| | 216.66 | 17.34 | 8.00 | 12.00 | 254.00 TTL |

USD
ADT CVG TW X/STL TW MSP 92.59TW X/STL TW CVG 124.07USD216.66
END TW ZPCVG2STL2MSP2STL2 XF CVG3STL3MSP3STL3

Penalty amount: $75.00
Original fare amount: $200.00
New fare amount $254.00
Additional Collection: $129.00 ($54.00+75.00)

The outbound fare was priced using the original fare. However, the inbound flights no longer qualified for the original fare and were re-priced using historical new fares.

TAG I Example:

Ignore all flown segments. Re-price all un-flown segments using current fares.

| | BF | | TX USD | TX USD | |
|---|---|---|---|---|---|
| | USD | TX USD | ZP TAX | XF TAX | TOTAL USD |
| 001 | 178.89 | 16.11 | 2.00 | 6.00 | 203.00 |
| | | | | | LE14NR*LE14CTN |
| | 178.89 | 16.11 | 2.00 | 6.00 | 203.00 TTL |

USD
ADT STL 1P MSP 62.381P CVG 116.51USD178.89END 1P
1P ZPSTL1MSP1 XF STL3MSP3 REBOOK 02/L 03/L

Original fare amount: $473.00
Ignore flown segment (CVGSTL)
Ignore value of original ticket—Tag I option to buy a new ticket
New fare amount of un-flown segments (STLMSP and MSPCVG) $203.00
Purchase of a new ticket: $203.00

Once the agent initiates the reissue request, a master work record is built containing the original ticket data including the original ticketing date, the ticketed itinerary and fare basis codes per flight coupon, the fare ladder data, tax codes and tax amounts, base fare amount, equivalent fare amount and total fare amount, the applicable currency codes, country code of ticket issue and flight coupon status codes and the new itinerary flight data including the passenger changed flight segments. The reissue package parses the fare ladder to determine the original fare construction and then compares the old and new itineraries to determine the point of passenger change and the impact to the rest of the itinerary. This data is used in a matching process once the original fares are located in the historical fares database to determine the applicable reprice scenarios (processing tags) to employ. Originally ticketed fares are located in the historical fares database either by searching the market city pair record or by historically repricing the original itinerary and storing pointers to the reissue rule provisions during the process. Once all of the reissue rule provisions are located, a matching process occurs to determine the applicable reissue rules. Data used in matching the applicable reissue process tags includes the date of the original ticket, the time of the passenger change (before or after departure of the itinerary), the type of passenger change (outbound travel or return travel), and the type of change to ticketed cities (change to stopover or connection points, change to origin/destination). A repricing data map is built to store all applicable processing tags and the restrictions that go with each scenario along with data to determine the penalty amount later in the process. Once all applicable reprice provisions are stored, the processing tags must be evaluated as to how each applies to the new itinerary for each pricing attempt. Processing tags are evaluated as they relate to the changed itinerary and pricing tags are built for each scenario. The following illustrates the evaluation of the repricing data map:

Based on the matched reissue table sequences, determine the applicable permutations for all fare components. Once the permutations are determined (1) identify types of fares for each fare component based upon the most restrictive pricing philosophy; (2) resolve the most restrictive to the equivalent rapid repricing pricing tag; (3) apply the reissue restrictions and conditions from the reissue table sequences that must be validated using the applicable rapid repricing pricing tag; (4) return the lowest add-collect/highest refund result.

Using the algorithm defined above, the reprice data map is completed. The pricing package is entered and each pricing tag is driven through the pricing system, validating all applicable rules and restrictions from the carrier's fare rule data. For each pricing tag, the repricing data map is accessed to determine what type of fares should be processed. The pricing tag may access the historical fares database to keep the originally ticketed fare or price other historical fares, the tag may price using current fares or a combination of both historical and current fares. The repricing data map also contains reprice restrictions that must be validated along with applicable fare rule data for replacement fare candidates. Within a pricing tag, there may be multiple permutations that contain unique reprice restrictions. As potential replacement fare candidates pass all fare rules and reprice restrictions, a unique permutation number is assigned to distinguish which fare candidates relate to which pricing tag permutation. Any successful reprice solution must contain replacement fare combinations with the same unique permutation number. During the repricing process, the applicable penalties are calculated based on the original fares' rule data, the type of changes made to the itinerary and the reprice solution's fare construction. Tax calculation processing occurs on each reprice solution. When the first pricing tag is processed, the result is stored and the next pricing tag is driven. As each pricing tag completes, the process must determine the fare difference between the original ticket and the current reprice solution candidate including the difference in taxes, base fare amount and total fare amount, then add any applicable penalties and determine the refund or additional collection amount for the current reprice solution. Processing is done to determine the best result between the pricing tag currently being stored and the newly completed pricing tag, the lowest add/collect or highest refund solution is retained and the losing tag is discarded. After all pricing tags have completed, the overall lowest add/collect or highest refund reprice solution is retained and the repricing process continues to recalculate the next alternate itinerary. Multiple results are then returned to the requestor.

The system and method of the present invention have been described as computer-implemented processes. It is important to note, however, that those skilled in the art will appreciate that the mechanisms of the present invention are capable of being distributed as a program product in a variety of forms, and that the present invention applies regardless of the particular type of signal bearing media utilized to carry out the distribution. Examples of signal bearing media include, without limitation, recordable-type media such as diskettes or CD ROMs, and transmission type media such as analog or digital communications links.

The corresponding structures, materials, acts, and equivalents of all means plus function elements in any claims below are intended to include any structure, material, or acts for performing the function in combination with other claim elements as specifically claimed.

Those skilled in the art will appreciate that many modifications to the exemplary embodiment are possible without departing from the spirit and scope of the present invention. In addition, it is possible to use some of the features of the present invention without the corresponding use of the other features. Accordingly, the foregoing description of the exemplary embodiment is provided for the purpose of illustrating the principles of the present invention and not in limitation thereof since the scope of the present invention is defined solely by the appended claims.

What is claimed:

1. A method for automatic repricing of a revised travel itinerary, comprising:
receiving a ticket change request from a passenger;
analyzing a plurality of itinerary changes;
building a plurality of alternate flight selection criteria;
selecting target fares and determining classes of service criteria through interaction with a fares database;
building and automatically repricing alternate itineraries for a plurality of selected flight candidates;
displaying a plurality of results from the repriced alternate itineraries for selection by the passenger.

2. The method for automatic repricing of a revised travel itinerary of claim 1 further comprising:
selecting a list of potential flight candidates through interaction with a flight schedules and availability database; and
sorting the potential flight candidates for repricing based on target fares and available classes of service.

3. A method for pricing of alternate travel itineraries, comprising:
receiving a request to price a specific market without an itinerary;
analyzing a plurality of travel options requested including dates of travel, destinations, and times of departure or arrival;
selecting target fares and determining classes of service criteria through interaction with a fares database;
selecting a plurality of qualified flight candidates associated with the lowest target fares to build alternate itineraries;
repricing each alternate itinerary to determine a plurality of lowest fare results; and
displaying a plurality of the resulting lowest fare itineraries including a total price for each itinerary displayed.

4. The method for pricing of alternate travel itineraries of claim 3 further comprising constructing a lowest fare request for each alternate itinerary.

5. The method for pricing of alternate travel itineraries of claim 3 further comprising:
selecting a plurality of potential flight candidates through interaction with a flight schedules and availability database; and
qualifying the potential flight candidates through interaction with a fare rules database.

6. The method for pricing of alternate travel itineraries of claim 3 further comprising determining a strategy for sending the lowest fare itineraries through automatic repricing.

7. The method for pricing of alternate travel itineraries of claim 3 further comprising sorting the lowest fare results from a lowest fare to a highest fare.

8. A method for repricing a new itinerary, comprising:
comparing an originally ticketed itinerary to the new itinerary to determine the changes made by a passenger;
building a plurality of alternate flight selection criteria;
selecting a plurality of target fares and determining a plurality of available classes of service using a fares database;
building a plurality of alternate itineraries to submit for an automated recalculation of fares;
repricing each alternate itinerary based on a plurality of reissue provisions and any applicable waivers; and
displaying a plurality of alternate itineraries having the lowest fare results.

9. The method for repricing a new itinerary of claim 8 further comprising analyzing a fare ladder for the original ticket to determine an original fare construction.

10. The method for repricing a new itinerary of claim 8 further comprising determining if the changes were made before or after departure based on a flight coupon status from an original ticket.

11. The method for repricing a new itinerary of claim 8 further comprising:
selecting a plurality of potential flight candidates using a flight schedule and availability data;
sorting the flight candidates based on the target fares and available classes of service.

12. The method for repricing a new itinerary of claim 8 further comprising accessing a historical fares database to locate an original fare data and determining a plurality of reprice scenarios and restrictions based on the fare rule data associated with the originally ticketed fares.

13. The method for repricing a new itinerary of claim 12 further comprising building a repricing map with the plurality of repricing scenarios and restrictions.

14. The method for repricing a new itinerary of claim 13 further comprising determining an applicable penalty for each scenario.

15. The method for repricing a new itinerary of claim 13 further comprising comparing each repricing result to a previous repricing result and storing the repricing result having the lowest add collect or highest refund.

16. The method for repricing a new itinerary of claim 8 wherein the displayed lowest fare results include pricing data, a fare difference, fees, and an add/collect or refind due amount.

17. The method for repricing a new itinerary of claim 8 wherein the step of repricing comprises repricing the revised itinerary using the same fares as originally ticketed.

18. The method for repricing a new itinerary of claim 8 wherein the step of repricing comprises repricing the revised itinerary using the historical same fares for all unchanged fare components up to the beginning of the first change component, and using current fares beginning with the first changed fare component.

19. The method for repricing a new itinerary of claim 8 wherein the step of repricing comprises repricing the revised itinerary using the historical same fares for all flown fare components, and using current fares for all partially flown or unflown fare components.

20. The method for repricing a new itinerary of claim 8 wherein the step of repricing comprises repricing the revised itinerary using the historical new fares for all flown fare components, and using current fares for all partially flown or unflown fare components.

21. The method for repricing a new itinerary of claim 8 wherein the step of repricing comprises repricing the revised itinerary using the historical new fares.

22. The method for repricing a new itinerary of claim 8 wherein the step of repricing comprises repricing the revised itinerary using the current fares.

23. The method for repricing a new itinerary of claim 8 wherein the step of repricing comprises determining a residual value for the itinerary using historical fares for each flown portion, and applying the residual value to unflown portions that are priced using current fares.

24. The method for repricing a new itinerary of claim 8 wherein the step of repricing comprises repricing all flown segments using historical new fares, subtracting the flown repriced solution from the original ticket price, determining a residual value, repricing all unflown flight segments using current fares, and applying any residual value to the repriced segments.

25. The method for repricing a new itinerary of claim 8 wherein the step of repricing comprises repricing all unchanged fare components up to the beginning of the first changed fare component using historical same fares, and repricing all unflown fare components using historical new fares.

26. The method for repricing a new itinerary of claim 8 wherein the step of repricing comprises repricing the unflown segments of the revised itinerary using the current fares.

27. A system for automatic repricing of a revised travel itinerary, comprising:
a processor for executing a plurality of components for enabling automatic repricing of the revised itinerary including:
a component for receiving a ticket change request from a passenger;
a component for analyzing a plurality of itinerary changes;
a component for building a plurality of alternate flight selection criteria;
a component for selecting target fares and determining classes of service criteria through interaction with a fares database;
a component for building and automatically repricing alternate itineraries for a plurality of selected flight candidates;
a component for displaying a plurality of results from the repriced alternate itineraries for selection by the passenger.

28. The system for automatic repricing of a revised travel itinerary of claim 28 further comprising:
a component for selecting a list of potential flight candidates through interaction with a flight schedules and availability database; and
a component for sorting the potential flight candidates for repricing based on target fares and available classes of service.

29. A system for automatic repricing of alternate travel itineraries, comprising:
a processor for executing a plurality of components for enabling automatic repricing of alternate itineraries, the plurality of components including:
a component for receiving a request to price a specific market without an itinerary;
a component for analyzing a plurality of travel options requested including dates of travel, destinations, and times of departure or arrival;
a component for selecting target fares and determining classes of service criteria through interaction with a fares database;
a component for selecting a plurality of qualified flight candidates associated with the lowest target fares to build alternate itineraries;
a component for repricing each alternate itinerary to determine a plurality of lowest fare results; and
a component for displaying a plurality of the resulting lowest fare itineraries including a total price for each itinerary displayed.

30. The system for pricing of alternate travel itineraries of claim 29 further comprising:
a component for selecting a plurality of potential flight candidates through interaction with a flight schedules and availability database; and
a component for qualifying the potential flight candidates through interaction with a fare rules database.

31. A system for repricing a new itinerary, comprising:
a processor for executing a plurality of components for enabling automatic repricing of alternate itineraries, the plurality of components including:
a component for comparing an originally ticketed itinerary to the new itinerary to determine the changes made by a passenger;
a component for building a plurality of alternate flight selection criteria;
a component for selecting a plurality of target fares and determining a plurality of available classes of service using a fares database;
a component for building a plurality of alternate itineraries to submit for an automated recalculation of fares;
a component for repricing each alternate itinerary based on a plurality of reissue provisions and any applicable waivers; and
a component for displaying a plurality of alternate itineraries having the lowest fare results including pricing data, a fare difference, fees, and an add/collect or refund due amount.

32. The system for repricing a new itinerary of claim 31 further comprising:
a component for selecting a plurality of potential flight candidates using a flight schedule and availability data;
a component for sorting the flight candidates based on the target fares and available classes of service.

33. The system for repricing a new itinerary of claim 31 further comprising a component for accessing a historical fares database to locate an original fare data and determining a plurality of reprice scenarios and restrictions based on the fare rule data associated with the originally ticketed fares.

34. The system for repricing a new itinerary of claim 31 further comprising a component for comparing each repricing result to a previous repricing result and storing the repricing result having the lowest add collect or highest refund.

35. A computer readable medium containing instructions for controlling a computer system to automatically reprice a revised travel itinerary, by:
receiving a ticket change request from a passenger;
analyzing a plurality of itinerary changes;
building a plurality of alternate flight selection criteria;
selecting target fares and determining classes of service criteria through interaction with a fares database;
building and automatically repricing alternate itineraries for a plurality of selected flight candidates;
displaying a plurality of results from the repriced alternate itineraries for selection by the passenger.

36. The computer readable medium containing instructions for controlling a computer system to automatically reprice a revised travel itinerary of claim 35, by:
selecting a list of potential flight candidates through interaction with a flight schedules and availability database; and
sorting the potential flight candidates for repricing based on target fares and available classes of service.

37. A computer readable medium containing instructions for controlling a computer system to automatically price alternate travel itineraries, by:
receiving a request to price a specific market without an itinerary;
analyzing a plurality of travel options requested including dates of travel, destinations, and times of departure or arrival;
selecting target fares and determining classes of service criteria through interaction with a fares database;
selecting a plurality of qualified flight candidates associated with the lowest target fares to build alternate itineraries;
repricing each alternate itinerary to determine a plurality of lowest fare results; and
displaying a plurality of the resulting lowest fare itineraries including a total price for each itinerary displayed.

38. The computer readable medium containing instructions for controlling a computer system to automatically price alternate travel itineraries of claim 37, by:
selecting a plurality of potential flight candidates through interaction with a flight schedules and availability database; and
qualifying the potential flight candidates through interaction with a fare rules database.

39. A computer readable medium containing instructions for controlling a computer system to reprice a new itinerary, by:
comparing an originally ticketed itinerary to the new itinerary to determine the changes made by a passenger;
building a plurality of alternate flight selection criteria;
selecting a plurality of target fares and determining a plurality of available classes of service using a fares database;
building a plurality of alternate itineraries to submit for an automated recalculation of fares;
repricing each alternate itinerary based on a plurality of reissue provisions and any applicable waivers; and
displaying a plurality of alternate itineraries having the lowest fare results.

40. The computer readable medium containing instructions for controlling a computer system to reprice a new itinerary of claim 39, by
selecting a plurality of potential flight candidates using a flight schedule and availability data;
sorting the flight candidates based on the target fares and available classes of service.

41. The computer readable medium containing instructions for controlling a computer system to reprice a new itinerary of claim 39 by accessing a historical fares database to locate an original fare data and determining a plurality of reprice scenarios and restrictions based on the fare rule data associated with the originally ticketed fares.

42. The computer readable medium containing instructions for controlling a computer system to reprice a new itinerary of claim 39 by comparing each repricing result to a previous repricing result and storing the repricing result having the lowest add collect or highest refund.
